(19) United States
(12) Patent Application Publication
(10) Pub. No.: US 2010/0069488 A1
(43) Pub. Date: Mar. 18, 2010

(54) Fire retardant composition

(76) Inventors: Michael John Mabey, Sherwood Park (CA); William Kish, Wadsworth, OH (US)

Correspondence Address: Christopher John Rudy, 209 Huron Ave., Ste. 8, Port Huron, MI, 48060, US

(21) Appl. No.: 12/586,069

(22) Filed: Sep. 16, 2009

Related U.S. Application Data
(60) Provisional application No. 61/192,322, filed on Sep. 17, 2008.
(60) Provisional application No. 61/194,204, filed on Sep. 25, 2008.
(60) Provisional application No. 61/197,095, filed on Oct. 23, 2008.
(60) Provisional application No. 61/273,613, filed on Aug. 6, 2009.

(51) Int. Cl. C09K 21/14; C09K 21/04; A01N 53/08; A01P 7/04

(52) U.S. Cl. 514/531; 524/62; 524/416

(57) ABSTRACT

A composition can embrace a fire retardant can be combined with a fluoropolymer, which can be a coating, for example, a paint, especially a latex paint, or which can be an organic solvent based coating, for example, a paint. The fire retardant can be an ammonium phosphate containing fire retardant, which can be combined with a fluoropolymer, a penetrating barrier, borate-containing formulation having resistance to water damage with protective properties coming from materials used in food packaging and cosmetics, and/or a medium-to-long chain polar carboxyl substance to make a composition. Also, a composition can embrace a fire retardant formulation having a cross-linked component, which composition may be a coating, for example, a paint or stain, especially a latex paint. The cross-linked component may be a base of the paint or stain, say, a vinyl acetate base of the fire retardant latex paint. At least one other active agent, for example, a mold inhibitor and/or an insecticide, may be included. The composition can be used by contacting it with a substrate, which beneficially is otherwise flammable. The composition or its residue may be found in combination with the substrate.

This claims benefits in accordance with 35 USC 119(e) of provisional patent application Nos. U.S. 61/192,322 filed on Sep. 17, 2008 A.D., U.S. 61/194,204 filed on Sep. 25, 2008 A.D., U.S. 61/197,095 filed on Oct. 23, 2008 A.D., and U.S. 61/273,613 filed on Aug. 6, 2009 A.D. The specifications of those applications in their entireties are incorporated herein by reference.

### FIELD AND PURVIEW OF THE INVENTION

This concerns a composition, respective to the priority documents, embracing a fire retardant combined with a fluoropolymer, say, as a paint, especially a latex; that is fire retardant and having a cross-linked component, say, as a coating such as a paint or stain, for example, a latex paint where an acrylic base is cross-linked; embracing a fire retardant combined with a fluoropolymer, especially an organic solvent based product; and embracing an ammonium phosphate fire retardant combined with a fluoropolymer, a penetrating barrier, borate-containing formulation having resistance to water damage with protective properties coming from materials used in food packaging and cosmetics and/or a medium-to-long chain polar carboxyl substance, an illustration of which is a stearate, and which can be in a form of a paint, especially a latex. The composition may have another active agent, for instance, a mold inhibitor and/or an insecticide. Of concern also are methods to make and use the composition, and a substrate in combination with the composition or residue whereof.

### BACKGROUND TO THE INVENTION

Various fire retardant compositions are known. Certain of these can be in a form of an intumescent composition, coating or paint. A highly effective fire retardant intumescent latex paint is commercially available from NO-BURN, INC., Wadsworth, Ohio as NO-BURN® PLUS latex paint product. This can be employed, for example, in residential and commercial structures including homes to provide fire resistant properties to the structure. Compare, patent application Pub. Nos. US 2005/0138888 A1 (e.g., Form #2 Agent) and US 2005/0022466 A1. A mold inhibitor can be employed with such a product as NO-BURN PLUS MIH fire retardant intumescent latex paint with mold inhibitor from NO-BURN, INC. Note, patent application Pub. No. US 2006/0167131 A1 and U.S. Pat. No. 7,482,395 B2. An insecticide may be added. See, patent application Pub. Nos. US 2007/0185238 A1 and US 2008/0054230. See also, patent application Pub. Nos. US 2006/0189232 A1; US 2007/0170404 A1; and US 2007/0176156 A1.

Other ammonium phosphate containing fire retardant compositions are known. See, e.g., U.S. Pat. No. 6,982,049 B1 and U.S. Pat. No. 6,989,113 B1; and patent application Pub. Nos. US 2006/0189232 A1; US 2007/0170404 A1; and US 2007/0176156 A1, in addition to the aforementioned Pub. Nos. US 2005/0138888 A1 (e.g., Form #1, #3 and #4 agents) and US 2005/0022466 A1.

Other art is known. See, e.g., Knipe, patent application Pub. No. US 2005/0217537 A1. Note, Gottfried, U.S. Pat. No. 5,723,515.

Fire retardant paint products, as useful as they are, are under continual development. Among various aesthetic characteristics of such products is the durability of their color, which in the eyes of the consumer can be important. Another characteristic, which is more critical along the lines of performance in certain locations, is that many fire retardant products, particularly those which employ a water soluble fire retardant ingredient such as an ammonium phosphate, are generally limited to indoor applications owing to the water solubility of that ingredient, or the tendency for a vinyl acetate based polymer to soften when exposed to water. The fire retardant intumescent latex paint accordingly may soften under conditions of high humidity, direct contact with water, and extended weathering, or when applied to a substrate in a factory setting where pieces of the substrate, say, siding, are stacked for storage, resulting in sticking. Most intumescent coatings are manufactured with a very high pigment volume concentration, which also leaves the polymer backbone susceptible to softening and loss of adhesion when exposed to moisture or the elements in general.

Various conventional paints and paint formulation bases may have long lasting color retention, chalk resistance, stain resistance, etc. Among these, for example, are touted various formulations that are or are made to include a polyvinylidene fluoride resin such as a KYNAR® resin as in a KYNAR® 301F, 500, 710, 741F or 9301 or KYNAR® AQUATEC® product. Compare, U.S. Pat. No. 6,635,714 B1 and U.S. Pat. No. 7,037,966 B2. See also, U.S. Pat. No. 6,833,414 B2.

Other treatments exist, for example, for lumber, which is, of course, flammable. Many of these do not primarily concern fire retardant capability although some fire retardant capability may be provided with penetrating barrier, borate-based formulations, for one example, a Class B ASTM E-84-05 rating. Among these is DRIWRAP® coating material for wood and wood-based composites from Kop-Coat, Inc., Pittsburgh, Pa. It is a spray-applied thin coating, which combines water and mold resistance, is breathable and resistant to water damage, contains a preservative that creates a barrier that is resistant to mold, and has its protective properties coming from materials that are used in food packaging and cosmetics. Compare, U.S. Pat. No. 5,468,284 and U.S. Pat. No. 6,416,789 B1 and U.S. Pat. No. 6,582,732 B1. Note, patent application publication No. WO 2006/127016 A1; and Pub. Nos. US 2006/0269677 A1, US 2009/0088481 A1 and US 2009/0143334 A1. See also, Ross, A., “New Penetrating Barrier Treatment for Wood and Wood Composites,” Proceedings of the American Wood-Preservers' Association, Austin, Tx., Apr. 9-11, 2006; Kop-Coat Wood Protection Products, Kiln-Dried Lumber (www.kop-coat.com/kilndried.asp), 2009. Note also, the TRU-CORE® process for protecting wood products of Kop-Coat, Inc., which can deliver preservation ingredients to the center core of lumber products without the expensive traditional use of pressure treatments. Compare, patent application publication No. WO 2006/127016 A1. See also, patent application Pub. Nos. US 2006/0269677 A1, US 2009/0088481 A1 and US 2009/0143334 A1.

Other products may provide water resistance. For example, although not a fire retardant, Thompson's Water Seal product is a solvent-borne, stearate-based water proofer for a variety of surfaces including wood, but not plywood, and other porous surfaces.

Cross-linking of polymers to harden the same in general is known.

Trade literature notwithstanding, formulation and compatibility may not always be straightforward.

It would be desirable to improve the art. It would be desirable to ameliorate if not solve one or more of the problems in the art. It would be desirable to provide an alternative to the art.

### A FULL DISCLOSURE OF THE INVENTION

Provided, in general, is a composition comprising a fire retardant in combination with a fluoropolymer. The composition may be a coating, for example, a paint, especially a latex paint. The composition can be an organic solvent based coating, for example, a paint. The fire retardant can be an ammonium phosphate containing fire retardant, which can be in combination with a fluoropolymer, a penetrating barrier, borate-containing formulation having resistance to water damage with protective properties coming from materials used in food packaging and cosmetics, and/or a medium-to-long chain polar carboxyl substance. Such a composition can be made by contacting a fire retardant, optionally with another active agent, with a fluoropolymer, or with the fluoropolymer, the penetrating barrier, borate-containing formulation and/or the medium-to-long chain polar carboxyl substance, under conditions sufficient to form the composition.

Provided also, in general, is a composition comprising a fire retardant formulation having a cross-linked component, which composition may be a coating, for example, a paint or stain, especially a latex paint. The cross-linked component may be a base of the paint or stain, say, a vinyl acetate base of the fire retardant latex paint. Such a composition can be made by contacting a fire retardant formulation, optionally with another active agent, with a cross-linking agent under conditions sufficient to form the composition.

The composition may further include at least one other active agent, for example, a mold inhibitor and/or an insecticide. The insecticide may be, for example, a termiticide.

The composition can be used by contacting it with a substrate, which beneficially is otherwise flammable. Another aspect is the composition or its residue in combination with the substrate.

The invention is useful in protecting building structures, their contents and/or their occupants, in general, from fire, optionally mold or insect damage or annoyance, and so forth.

Significantly, by the invention, the art is advanced in kind. Problem(s) in the art is(are) ameliorated if not overcome. An effective, cost-efficient, aesthetically pleasing and/or generally safe fire retardant providing long-lasting color retention, chalk resistance, stain resistance and overall durability or exterior durability is provided. Exterior applications may be made. Water resistance may be significant. Other active agents can provide protection from mold, notably Stachybotrys chartarum, i.e., toxic black mold, and/or from insects, notably termites, and so forth. Thus, for example, flammable construction stock such as of wood can be provided with good fire retardant capability and effective control of toxic black mold as well as termites. Application of the paint is simple and easy, and coverage can be excellent. The composition can advantageously be applied directly to a wide range of materials, which may include wood, plywood, oriented strand board and chip board sheathing, paper, fabrics, corrugated board materials, and so forth and the like. It is efficient and reasonably safe to manufacture, store, transport and use. One of the many advantages of the present composition is that, since it can be applied directly to building materials before or on site, it greatly reduces financial and environmental costs in new structures of rendering materials fire retardant and termite resistant. Further, building materials may be rendered fire retardant and optionally mold- and/or termite-repellant after construction by application of the present composition. In a particularly advantageous embodiment, the composition may be considered to be a highly durable, exterior intumescent fire retardant, mold inhibitor, and termite repellant latex paint, which can provide these properties at once through a common application of a beautiful and highly durable paint. Cross-linking may be suited to extend the service life in an intumescent latex paint for exterior applications. In another particularly advantageous embodiment, the composition may be considered to be a highly durable, exterior intumescent fire retardant, mold inhibitor, and termite repellant solvent based paint, which may provide these properties at once through a common application of a beautiful and highly durable paint. The composition may have a “Class A” flame spread rating under the ASTM-E84 test.

Numerous further advantages attend the invention.

The invention can be further understood by the additional detail set forth below. The same, like that set forth above, is to be taken in an illustrative and not necessarily limiting sense.

Broadly, a fire retardant can be combined with a fluoropolymer. An intumescent fire retardant paint, which may be an aqueous based latex paint, or an organic solvent based coating, which may be an intumescent fire retardant stain or paint, may include the fluoropolymer. Broadly also, in one embodiment, an ammonium phosphate containing fire retardant paint is combined with a fluoropolymer, a penetrating barrier, borate-containing formulation having resistance to water damage with protective properties coming from materials used in food packaging and cosmetics, and/or a medium-to-long chain polar carboxyl substance. An intumescent fire retardant paint, which may be an aqueous based latex paint, may include the fluoropolymer and/or penetrating barrier, borate-containing formulation having resistance to water damage with protective properties coming from materials used in food packaging and cosmetics. Broadly, too, a fire retardant formulation can be combined with a cross-linked component. A mold inhibitor, insecticide and/or other active agent may be combined therewith.

The term, “fire retardant,” herein can refer to an ingredient for a composition or to the composition that, when applied to a flammable material, provides thermal protection for the material. The composition may be a coating, for instance, a paint, say, a latex paint. In general, this may be done by reducing or perhaps even eliminating the tendency of the material to burn and/or reducing the rate of flame spread along the surface of the material. Preferably, use of the fire retardant composition, for example, on a solid material as the substrate, reduces surface burning characteristics significantly, say, at least about 10%, at least about 25%, or at least about 50%, when compared to untreated material, as tested by an appropriate test. For example, the test may be the ASTM E84 Steiner Tunnel Test. Without being bound by any theory, the present fire retardant paint can be considered to be an intumescent fire reactant. Although it looks and applies like regular paint, its chemical composition changes drastically when introduced to heat. Thus, when heat is applied, the fire retardant paint of the invention may “foam up” to form an intact, fire-resistive “char-barrier” to protect the treated surface. As a result, fire is robbed of fuel and oxygen, generates less heat and smoke, and may in some circumstances extinguish itself.

Any suitable fire retardant ingredient(s) may be employed. The same may be a principal fire retardant ingredient.

For an instance, such an ingredient, with respect to combination with a fluoropolymer, especially for a latex paint form of the composition, which may be cross-linked with a cross-linked component, may be an ammonium phosphate, which may embrace a mono- and/or di-ammonium phosphate, a polyphosphate, and so forth and the like, a borate, an organic halide such as a chloride or generally more effectively a bromide or combination of chloride and bromide, an organophosphorus compound, which may be an organic phosphate, to include melamine phosphates such as melamine phosphate, melamine orthophosphate, dimelamine phosphate, dimelamine orthophosphate, melamine pyrophosphate, melamine polyphosphate, blends therewith, and so forth. Melamine and/or melamine cyanurate may be employed. For example, such an ingredient may be or include an ammonium polyphosphate.

For another instance, the suitable fire retardant ingredient(s), with respect to combination with a solvent based composition, may include an ammonium phosphate, which may embrace a mono- and/or di-ammonium phosphate, a polyphosphate, which may be largely if not more completely insoluble in water, and so forth and the like; a borate; an organic halide such as an organic chloride or bromide or combination of chloride and bromide, say, as a halogenated alkane or wax; an organophosphorus compound, which may be an organic phosphate, to include melamine phosphates such as melamine phosphate, melamine orthophosphate, dimelamine phosphate, dimelamine orthophosphate, melamine pyrophosphate, melamine polyphosphate, blends therewith, and so forth. Melamine and/or melamine cyanurate may be employed. The fire retardant ingredient(s) may be employed in combination. For instance, such ingredient(s) can include a powdered melamine, a chlorinated paraffin, and an ammonium polyphosphate. A carbonific or other type of fire inhibiting agent, which acts differently than the type(s) of fire retardant ingredient(s) set forth above, may also be employed with or considered to be part of the fire retardant ingredient(s).

For another instance, when an ammonium phosphate containing fire retardant ingredient is employed, especially in combination with a fluoropolymer, a penetrating barrier, borate-containing formulation having resistance to water damage with protective properties coming from materials used in food packaging and cosmetics, and/or a medium-to-long chain polar carboxyl substance, another fire retardant ingredient also may be employed and may be a borate, an organic halide such as a chloride or generally more effectively a bromide or combination of chloride and bromide, an organophosphorus compound, which may be an organic phosphate, to include melamine phosphates such as melamine phosphate, melamine orthophosphate, dimelamine phosphate, dimelamine orthophosphate, melamine pyrophosphate, melamine polyphosphate, blends therewith, and so forth. Melamine and/or melamine cyanurate may be employed. The ammonium phosphate may embrace a mono- and/or di-ammonium phosphate, a polyphosphate, and so forth and the like. For example, it may be or include an ammonium polyphosphate. For instance, the fire retardant may be provided in a latex paint formulation, for example, NO-BURN® PLUS fire retardant latex paint or NO-BURN PLUS® MIH fire retardant latex paint with mold inhibitor. Note, U.S. patent application Pub. Nos. 2005/0138888 and US 2006/0167131 A1; U.S. Pat. No. 7,482,395 B2. The fire retardant may be provided in a latex paint formulation that may include an insecticide. See, e.g., patent application Pub. Nos. US 2007/0185238 A1 and US 2008/0054230 A1.

A “fluoropolymer” is an organic polymer which contains fluorine moieties.

Any suitable fluoropolymer may be employed. For instance, the fluoropolymer may embrace, in general, a fluoropolymer homopolymer, for instance, polyvinylidene fluoride (PVDF) and/or a copolymer or modified fluoropolymer, for instance, a fluoropolymer-acrylic blend including those known in the art as an acrylic-modified fluoropolymer (AMF), which can include a lower alkyl(meth)acrylate such as methyl, ethyl and/or propyl, butyl and higher (meth)acrylate(s) and so forth; a copolymer of vinylidene fluoride (VDF) and a perhalogenated monomer such as hexafluoropropylene (HFP), chlorotetrafluoroethylene (CTFE) or tetrafluoroethylene (TFE). Other acrylic component monomers for copolymerization may include methacrylic or itaconic acid, hydroxyethyl acrylate or methacrylate, carbonyl or acetoacetate functional monomers, various alkoxysilane methacrylates or acrylates, vinyl esters, vinyl ethers, and styrene. A latex dispersion may employ a fluoropolymer having little or no detectable crystalline melting peak. See, e.g., U.S. Pat. No. 6,635,714 B1. A KYNAR® AQUATEC® emulsion can be employed for a latex paint. A KYNAR® 500 PVDF product and/or a Solvay Solexis Hylar® 5000 PVDF product, for instance, can be employed for a solvent based, also known as “oil based,” paint, which employs a volatile organic compound as a vehicle. Any suitable amount may be employed.

The fire retardant and fluoropolymer may be combined in any suitable manner. A simple expedient, for example, can be by top coating a fire retardant composition that resides on a substrate with a fluoropolymer coating, say, by painting a fluoropolymer containing paint, oil based and/or latex, over an intumescent fire retardant paint such as NO-BURN® PLUS latex paint on siding, under eaves, or other substrate or portion of a structure. Another embodiment can be the mixing of fire retardant and fluoropolymer into one mixture, for example, a liquid paint. The latter may be accomplished, for example, by the addition of KYNAR® AQUATEC® liquid to NO-BURN® PLUS latex paint or NO-BURN® PLUS MIH latex paint with mold inhibitor, and so forth. As another instance, mixing fire retardant and fluoropolymer into one mixture, for example, a liquid, organic solvent based paint, can provide for the present composition. The latter may be accomplished, for instance, by the addition of KYNAR® 500 or HYLAR® 5000 PVDF product to an oil based paint foundation. Also, the ammonium phosphate fire retardant plus fluoropolymer, a penetrating barrier, borate-containing formulation having resistance to water damage with protective properties coming from materials used in food packaging and cosmetics, and/or medium-to-long chain polar carboxyl substance may be combined in any suitable manner. A simple expedient, for example, can be by top coating a fire retardant composition that resides on a substrate with a coating of the fluoropolymer, penetrating barrier, borate-containing formulation having resistance to water damage with protective properties coming from materials used in food packaging and cosmetics, and/or medium-to-long chain polar carboxyl substance, say, by painting an oil based or latex paint with fluoropolymer, penetrating barrier, borate-containing formulation having resistance to water damage with protective properties coming from materials used in food packaging and cosmetics, and/or medium-to-long chain polar carboxyl substance over an intumescent fire retardant paint such as NO-BURN® PLUS latex paint on siding, under eaves, or other substrate or portion of a structure. Another embodiment can be the mixing of fire retardant and fluoropolymer, penetrating barrier, borate-containing formulation having resistance to water damage with protective properties coming from materials used in food packaging and cosmetics, and/or medium-to-long chain polar carboxyl substance into one mixture, for example, a liquid paint. The latter may be done, for example, by adding KYNAR® AQUATEC® liquid, DRIWRAP® coating material for wood and wood-based composites, and/or aluminum stearate to NO-BURN® PLUS latex paint or NO-BURN® PLUS MIH latex paint with mold inhibitor, and so forth.

Fire retardant and fluoropolymer paint formulations can vary. A latex formulation may include ingredients added with water in percentages, which may be considered approximate:

| | | |
|---|---|---|
| Ammonium phosphate solids | 10 to 40% | by weight |
| Fluoropolymer latex resin, e.g., | 5 to 30% | by weight |
| fluoropolymer acrylic type | | |
| Nitrogenous spumific, e.g., melamine powder | 5 to 15% | by weight |
| Carbonific, e.g., polyol | 5 to 15% | by weight |
| Generally inert pigment(s) and/or filler(s), | 5 to 10% | by weight |
| possibly titanium dioxide | | |
| Soda lime borosilicate or other glass | 1 to 5% | by weight |
| Ester alcohol | 0.5 to 1.5% | by weight |
| Hydroxyalkylcellulosic | 0.1 to 1% | by weight |
| Wetting and/or other agent(s), which may | 0.1 to 5% | by weight. |
| include pH adjuster(s) and/or buffer(s) | | |

As the nitrogenous spumific, any suitable hydrogen-containing nitrogenous organic compound may be employed. Preferably, the spumific is compatible with the other components employed, and further is dispersible therewith. For instance, melamine may be employed.

As the carbonific, any suitable hydroxyl-containing organic compound may be employed. Preferably, the carbonific is compatible with the other components employed, and further is dispersible in the water or other diluent employed. For instance, a polyol may be employed. The polyol may be a compound such as glycerol, pentaerythritol, dipentaerythritol, tripentaerythritol; a sugar, say, a monosaccharide such as a triose, tetrose, pentose, hexose, heptose, or octose, to include an aldose or a ketose, or a disaccharide, a trisaccharide, a polysaccharide, and so forth; and/or a starch. A combination of polyols may be employed. Pentaerythritol is preferred.

Any suitable generally inert pigment(s) and/or filler(s) may be employed, and an opacifying agent may be included with such. A titanium dioxide powder may be selected as the opacifying agent. A calcium carbonate may be employed. Tint(s) and/or color(s) may be added to obtain a pastel or colored paint.

A glass additive such as borosilicate and/or other glass may be provided, preferably in the form of glass bubbles of a size in the range of a powder. This improves the body of the paint and may provide it with thixotropic or other advantageous viscous flow properties.

As the ester alcohol, any suitable ester alcohol may be employed. The ester alcohol may be an alkanol alkylate, for example, 2,2,4-trimethyl-1,3-pentanediol monoisubutyrate. The ester alcohol functions as a coalescent for film integrity, and so forth.

As the hydroxyalkylcellulosic, any hydroxyalkylcellulose or suitable analog or derivative thereof may be employed. It may be hydroxymethylcellulose or hydroyethylcellulose, preferably the latter. The hydroxyalkylcellulosic functions to improve the flow and rheology of the finished paint solution or suspension, reducing sag and improving film build.

Wetting and/or other agent(s) may be employed. Such agent(s) can include what may be considered surface tension lowering agents, surfactants, defoaming agents, dispersing agents, paint preservatives, which may be biocidal, and so forth and the like. Thus employed in minor amounts may be a pigment dispersing agent such as an alkali metal salt of a polymeric carboxylic acid, say, the sodium salt of a copolymer of maleic acid; a defoamer colloid such as an acrylic polymer, say, sodium polyacrylate; a silicone surfactant such as a polyether modified alkyl polysiloxane, say, a polyether modified poly-dimethyl-siloxane, which may be employed neat or preferably in solution with a suitable solvent, say, about half dipropyleneglycol monomethyl ether (48%); a paint preservative/biocide such as containing 1,2-benzisothiazol-3(2H)-one, say, as an aqueous mixture containing 1,2-benzisothiazol-3(2H)-one, sodium hydroxide, and dipropyleneglycol; and a rheology modifier such as a hydrophobically modified ethylene oxide urethane block copolymer, which may be employed in an organic solvent mixture such as a mixture of butyl carbitol and water or without the organic solvent, say, in water only. A pH adjuster and/or buffer may be employed.

Other additive(s) may be employed.

Fire retardant and fluoropolymer oil based paint formulations can vary. A foundational fire retardant solvent or oil based paint formulation may include ingredients such as follows, which may be considered to be approximate:

| | | |
|---|---|---|
| Primary solvent, for instance, an aromatic organic liquid | 20 to 50% | by weight |
| or blend thereof, say, low odor mineral spirits | | |
| (LOMS) and/or xylene, e.g., 50% LOMS and | | |
| 50% xylene | | |
| Secondary solvent, which may act as a carbonific, a suitable | 2 to 10% | by weight |
| hydroxyl-containing organic compound compatible | | |
| and dispersible with the other ingredients, for instance, | | |
| a polyol, say, a glycol ether or polyoxyalkylene | | |
| composition, e.g., DOWANOL ® DPM | | |
| dipropylene glycol methyl ether | | |
| First film forming agent or polymer, for instance, a | 5 to 15% | by weight |
| (vinyl aromatic)-acrylic, say, a vinyl toluene- | | |
| acrylate and/or substituted vinyl toluene-acrylate | | |
| resin, which may, owing to its(their) burn | | |
| characteristics, enhance intumescence, e.g., | | |
| PLIOLITE ® VTAC-L vinyl toluene-acrylate | | |
| Newtonian low viscosity resin | | |
| Second film forming agent or polymer, for instance, | 1 to 5% | by weight |
| another (vinyl aromatic)-acrylic, say, a styrene- | | |
| acrylate and/or substituted styrene-acrylate resin, | | |
| which also may, owing to its(their) burn | | |
| characteristics, enhance intumescence, e.g., | | |
| PLIOLITE ® AC80 Newtonian and/or AC4 | | |
| thixotropic styrene-acrylate resin(s) | | |
| Fire retardant wax, for instance, a halogenated | 3 to 10% | by weight |
| paraffin, especially a short chain chlorinated | | |
| paraffin, e.g., CHLOROWAX ® 70 powder | | |
| Nitrogenous spumific, a suitable hydrogen-containing | 3 to 10% | by weight |
| nitrogenous organic compound compatible and | | |
| dispersible with the other ingredients, for instance, | | |
| a melamine powder, e.g., MELAFINE ® powder | | |
| Carbonific, for instance, a carbonaceous compound, say, | 3 to 10% | by weight |
| a polyol such as pentaerythritol and so forth, e.g., | | |
| Hercules Aqualon improved technical PE-200 | | |
| Ammonium phosphate, for instance, an ammonium | 10 to 30% | by weight |
| polyphosphate, especially a largely water | | |
| insoluble ammonium polyphosphate, e.g., | | |
| EXOLIT ® AP 422 fine particle | | |
| ammonium polyphosphate | | |
| Generally inert fillers and pigments, say, an inorganic | 5 to 15% | by weight. |
| opacifying agent such as calcium carbonate, | | |
| and so forth, e.g., titanium dioxide powder, | | |
| with which may include suitable colorant(s) | | |

More particular oil based paint foundational formulations can include those such as the following, where, again, percentages may be considered approximate:

| | *70% Formulation | *50% Formulation |
|---|---|---|
| Solvent (50% LOMS, 50% | 26.08% by weight | 43.10% by weight |
| xylene) | | |
| DOWANOL ® DPM glycol | 4.17% by weight | 6.90% by weight |
| ether | | |
| VTAC-L resin | 9.39% by weight | 6.73% by weight |
| AC4 resin | 2.09% by weight | 1.50% by weight |
| CHLOROWAX ® 70 powder | 7.56% by weight | 5.42% by weight |
| MELAFINE ® melamine | 8.35% by weight | 5.98% by weight |
| powder | | |
| PE-200 pentaerythritol | 8.45% by weight | 6.06% by weight |
| EXOLIT ® AP 422 | 24.00% by weight | 17.21% by weight |
| fine-particle ammonium | | |
| polyphosphate | | |
| Titanium dioxide powder | 9.91% by weight | 7.10% by weight. |

*The 70% and 50% formulations refer to the total percent solids of the final formulation as a wet mix.

To such a foundational fire retardant solvent or oil based paint formulation, or corresponding stain, varnish or other coating, is added the fluoropolymer ingredient, e.g., KYNAR® 500 and/or HYLAR® 5000 PVDF, in any suitable amount. The fluoropolymer may be added in general, independently at each occurrence, about from, say, 1% to 50%, 3% to 40%, 5% to 30%, 7.5% to 25%, or 10% to 20% by weight. Addition of the fluoropolymer may be made at any suitable time. For instance, the fluoropolymer ingredient may be added to an existing stock of liquid foundational fire retardant solvent or oil based paint, stain, varnish or other coating formulation; or it may be added with other ingredient(s) during formulation of the organic solvent based fire retardant intumescent paint, or stain, varnish or other coating hereof A glass additive such as borosilicate and/or other glass may be provided, preferably in the form of glass bubbles of a size in the range of a powder. This may improve the body of the paint and may provide it with thixotropic or other advantageous viscous flow properties. Other additive(s) may be employed.

Especially regarding the ammonium phosphate fire retardant plus fluoropolymer, a penetrating barrier, borate-containing formulation having resistance to water damage with protective properties coming from materials used in food packaging and cosmetics, and/or medium-to-long chain polar carboxyl substance, any suitable penetrating barrier, borate-containing formulation having resistance to water damage with protective properties coming from materials used in food packaging and cosmetics can be employed. For example, such a formulation can embrace the DRIWRAP® coating material for wood and wood-based composites, which is a spray-applied thin coating that combines water and mold resistance, is breathable and resistant to water damage, contains a preservative that creates a barrier that is resistant to mold, and has its protective properties coming from materials that are used in food packaging and cosmetics. The DRIWRAP® coating material for wood and wood-based composites is commercially available from Kop-Coat, Inc. See, U.S. Pat. No. 5,468,284 and U.S. Pat. No. 6,416,789 B1 and U.S. Pat. No. 6,582,732 B1. See also, patent application publication No. WO 2006/127016 A1; and Pub. Nos. US 2006/0269677 A1, US 2009/0088481 A1 and US 2009/0143334 A1. Any suitable amount may be employed.

Especially regarding the ammonium phosphate fire retardant plus fluoropolymer also, a penetrating barrier, borate-containing formulation having resistance to water damage with protective properties coming from materials used in food packaging and cosmetics, and/or medium-to-long chain polar carboxyl substance, any suitable a medium-to-long chain polar carboxyl substance may be employed. It may be a carboxylic acid, ester or salt of a carboxylic acid, for instance, as a metal salt. The valence of the metal or other cation in the substance may be two or more. This substance may be a stearate, which, for example, may be or include aluminum stearate. A mixture of two or more different medium-to-long chain polar carboxyl substances may be employed. This substance, when considered as a pure compound, may accord with the following general formula:

(R—COO)ₘ-M

wherein:
“R” is, independently at each occurrence, an aliphatic moiety of about from ten to thirty carbons, to include about from twelve to twenty-five, to include about from fifteen to twenty; the aliphatic moiety, independently at each occurrence, may be saturated or unsaturated, for instance, being alkyl;
“m” is a suitable number, say, an integer of 1 or greater, to include 2 or greater, to include 3 or greater, and which, for example, may be 2 or 3; and
“M” is, independently at each occurrence, H so as to make an acid provided that “m” is 1; an organic ester moiety, say, to make an ester; and/or or a metal with a valence of “m,” say, to make a salt, examples of which may include Al, Ca, Mg, Zn and so forth and the like.
   Any suitable amount of the medium-to-long chain polar carboxyl substance may be employed.

Ammonium phosphate fire retardant plus fluoropolymer, penetrating barrier, borate-containing formulation having resistance to water damage with protective properties coming from materials used in food packaging and cosmetics, and/or medium-to-long chain polar carboxyl substance paint formulations can vary. A latex formulation may include ingredients added with water in percentages by weight, which may be considered approximate and which, of course, would be selected to total 100%:

| | |
|---|---|
| Ammonium phosphate solids | 10~40% |
| Nitrogenous spumific, e.g., melamine powder | 5~15% |
| Carbonific, e.g., polyol | 5~15% |
| Generally inert pigment(s) and/or filler(s), | 5~10% |
| possibly titanium dioxide | |
| Soda lime borosilicate or other glass | 1~5% |
| Ester alcohol | 0.5~1.5% |
| Hydroxyalkylcellulosic | 0.1~1% |
| Wetting and/or other agent(s), which may | 0.1~5% |
| include pH adjuster(s) and/or buffer(s) | |
| Fluoropolymer latex resin, e.g., | *0% or, say, 3~30% |
| fluoropolymer acrylic type | |
| Penetrating barrier, borate-containing formulation | *0% or, say, 1~70% |
| having resistance to water damage with | |
| protective properties coming from materials | |
| used in food packaging and cosmetics, e.g., | |
| DRIWRAP ® coating material | |
| Medium-to-long chain polar carboxyl substance, | *0% or, say, 0.1~20% |
| e.g., aluminum stearate | |

*At least some present from among these three ingredients collectively.

The nitrogenous spumific, carbonific, suitable generally inert pigment(s) and/or filler(s), glass additive, ester alcohol, hydroxyalkylcellulosic, and wetting and/or other agent(s) are as set forth above in the listed latex formulation. Also, other additive(s) may be employed.

With respect to the fire retardant formulation having a cross-linked component, a “cross-linked component” is a polymeric ingredient that has cross-links therewith. The cross links are typically formed from a cross-linking agent.

Any suitable cross-linked component may be employed. For instance, it may embrace, in general, with respect to a fire retardant latex paint, a cross-linked polyvinyl acetate, polyvinyl chloride, polyvinylidine chloride and/or fluoropolymer-acrylic blend, which may include those known in the art as acrylic-modified fluoropolymers as in U.S. Pat. No. 6,635,714 B1. A KYNAR® AQUATEC® emulsion may be employed. The cross-links may be provided, for instance, by employment of such a cross-linking agent as a liquid reactive melamine, say, a commercial grade hexamethoxymethylamine resin. For example, RESIMENE® AQ-7550 product may be employed. Thus, this reactive melamine may be employed so as to cross-link a polyvinyl acetate or polyvinyl chloride latex resin in an intumescent fire retardant latex paint formulation; pre-mixing of the RESIMENE® AQ-7550 reactive melamine with a small amount of a lower alkyl alcohol, say, methyl alcohol and/or ethyl alcohol, may be carried out to lower viscosity and improve mixing with the water of the formulation. And so, the cross-linking agent may not require baking to provide the cross-linked component. The cross-linking agent may require baking to provide the cross-linked component, say, if employing a reactive melamine such as CYMEL® 303 product in conjunction with a formulation capable of being baked.

Any suitable amount of cross-linker may be employed. For instance, with respect to a target component that may be turned into the cross-linked component, the cross-linker may be employed, independently at each occurrence, say, at about from 0.1% to 20% by weight, about from 0.5% to 10% by weight, about from 1% to 7.5% by weight, or about from 2% to 5% by weight; the cross-linker may be present, for instance, with respect to weight of total composition, independently at each occurrence, say, at about from 0.01% to 5% by weight, about from 0.05% to 2.5% by weight, or about from 0.1% to 1% by weight.

The fire retardant formulation with cross-linked component may be provided in any suitable manner. For instance, mixing of fire retardant formulation and cross-linking agent into one mixture, for example, a liquid paint may be employed. The latter may be accomplished, for example, by the addition of reactive melamine to NO-BURN® PLUS latex paint or NO-BURN® PLUS MIH latex paint with mold inhibitor, and so forth.

Fire retardant with cross-linked component paint formulations can vary. A latex formulation may include ingredients added with water in percentages, which may be considered approximate, as follows:

| | | |
|---|---|---|
| Ammonium phosphate solids, e.g., | 10 to 40% | by weight |
| ammonium phosphate powder | | |
| Thermoplastic latex resin, e.g., | 5 to 30% | by weight |
| polyvinyl acetate type | | |
| Nitrogenous spumific, e.g., melamine powder | 5 to 15% | by weight |
| Carbonific, e.g., polyol | 5 to 15% | by weight |
| Generally inert pigment(s) and/or filler(s), e.g., | 5 to 10% | by weight |
| powdered titanium dioxide | | |
| Soda lime borosilicate or other glass | 1 to 5% | by weight |
| Ester alcohol | 0.5 to 1.5% | by weight |
| Hydroxyalkylcellulosic | 0.1 to 1% | by weight |
| Cross-linking agent, e.g., a reactive melamine | 0.1 to 2% | by weight |
| such as RESIMENE ® AQ-7550 | | |
| Lower alkyl alcohol, e.g., methyl alcohol | 0.1 to 2% | by weight |
| Wetting and/or other agent(s) | 0.1 to 5% | by weight. |

Accordingly, the latex resin can be a cross-linked component in the formulation.

The nitrogenous spumific, carbonific, suitable generally inert pigment(s) and/or filler(s), glass additive, ester alcohol, hydroxyalkylcellulosic, and wetting and/or other agent(s) are as set forth above in the listed latex formulations. Also, other additive(s) may be employed.

The term, “mold inhibitor,” as employed herein is an agent that can kill, control, or prevent growth of mold, mildew, or fungus, and so forth and the like flora, especially when formulated with the present composition. A mold inhibitor may be fire retardant or fire accelerative, but, in the latter case, does not accelerate fire to a degree that the overall composition which contains the mold inhibitor cannot be considered to be a fire retardant composition. Preferably, however, use of the present composition with mold inhibitor, for example, on a solid material as the substrate, reduces growth of the flora of interest significantly, say, at least about 60%, at least about 85%, or at least about 99% or even at least about 99.9%, if it does not kill it outright, for a significant time, say, at least about thirty days, at least about six months, or at least about 360 days or a year, if not, in effect, indefinitely, as tested by appropriate test methodology. For example, the test method may be by ASTM D5590-94, Determination of Resistance of a Coating Material to Fungal Growth.

As the mold inhibitor, any suitable substance may be employed, alone or in combination with another mold inhibitor. Preferably, the mold inhibitor is compatible with the other components, and further is soluble or suspendable therewith. For instance, the mold inhibitor may be a quaternary organic ammonium halide, to include a quaternary alkyl ammonium halide, especially such a halide having at least one short chain and at least one medium chain alkyl group, for example, two of each, and an otherwise corresponding quaternary alkyl aromatic ammonium halide. The short chain alkyl group may be inclusive of, separately at each occurrence, a one- to an about five-carbon group, especially a one- to four-carbon group, for example, a methyl, ethyl, propyl, and so forth group. The medium chain alkyl group may be inclusive of, separately at each occurrence, an about six- to an about thirty-carbon group, especially a six- to an about twenty-carbon group, for example, hexyl, heptyl, octyl, nonyl, decyl, undecyl, dodecyl, a thirteen-, fourteen-, fifteen- or sixteen-, seventeen-, eighteen-, nineteen-, or twenty-carbon group, and so forth. Preferably, the short chain alkyl group is methyl and/or ethyl, especially methyl, and the medium chain alkyl group is an eight- to twelve-carbon group, to include a mixture thereof, especially decyl, which can be present as an n-alkyl group. The halide is advantageously a chloride. For example, the mold inhibitor employed may be didecyldimethylammonium chloride. An aromatic group, to include aryl, alkaryl and/or arylalkyl, for example, a benzyl and/or ethylbenzyl group may be present, for instance, in a quaternary organic to include a quaternary alkyl aromatic ammonium halide mold inhibitor, for example, alkyldimethylbenzylammonium chloride. The mold inhibitor may be a mixture containing more than one mold inhibitor compound. An increase in concentration of any quaternary ammonium halide mold inhibitor may provide for a corresponding reduction in the amount of ammonium phosphate or ammonium orthophosphate.

Any suitable amount of the mold inhibitor may be employed. The amount may be any that is sufficient to kill, control, or prevent growth of mold, mildew, or fungus, and so forth and the like flora, when the composition is applied to, and preferably dried on or in, a substrate. The insecticide may be, independently at each occurrence, say, from 0.01% to 50% by weight of total composition, say, from 0.1%, 1%, or 2% to 4%, 5% or 10%, for instance, 3%, by weight of the total composition.

The term, “insecticide,” is an agent that can kill, control and/or repel a target invertebrate. The target invertebrate can be an insect per se, for example, a termite, a carpenter, sweet or grease eating ant, a bee, hornet or wasp, a roach, a fly, a mosquito, a cricket, an earwig, a silverfish, a tick, a flea, a beetle, and so forth; another arthropod such as a spider, a centipede, and so forth; and/or a worm or even a snail or slug, and so forth. Target invertebrates considered building pests, which could include the termites, ants, bees, hornets and wasps, roaches, crickets, earwigs, silverfish, fleas, beetles, and spiders, especially termites, desirably are killed, controlled and/or repelled hereby.

Any suitable insecticide can be employed in the practice of the present invention, alone or in combination with another insecticide. Preferably, the insecticide is soluble or otherwise able to be carried with the remaining ingredients of the invention such as by dispersion, emulsion, and so forth, and preferably does not hinder any solubility or otherwise any capacity for being carried likewise of other ingredients of the composition of the invention, for example, the mold inhibitor. Preferably, too, the insecticide does not alter, at least significantly, other desirable physical characteristic(s) of the composition that would otherwise exist without it such as, for example, pH, viscosity, and so forth. Preferably also, the insecticide is stable in the composition before, i.e., “in the can,” and after application to the substrate, so as to provide for contact with the target invertebrate. An insecticide may be fire retardant or fire accelerative, but, in the latter case, does not accelerate fire to a degree that the overall composition which contains the insecticide cannot be considered to be a fire retardant composition. Preferably, the insecticide, when applied to a suitable substrate in a suitable amount, provides measurable protection to the substrate from the target invertebrate(s). The measurable protection may be tested by a standard protocol. For example, with the substrate wood and the target invertebrate a termite, the protection may be measured by the American Wood-Preservers' Association Standard E1-97 protocol. Be that as it may, the insecticide may be or include inorganic, organic, natural and/or synthetic components, thus perhaps being or including Arsenic, Lead, Mercury, Thallium, or a compound of such, Phosphorus, an organophosphate, Sulfur, an organothio compound, a chlorinated organic compound, a pyrethroid, carbamide, carbimide, cyclopropanecarboxylate, a pyrethrin, and/or a piperonyl ether; examples may include, malathion, parathion, diazinon (0,0-diethyl-0,2-isopropyl-6-methyl(pyrinodine-4-yl)phosphorthioate), permethrin ((3-phenoxyphenyl)methyl(+)cis-trans-3-(2,2-dichloroethenyl)-2,2-dimethylcyclopropanecarboxylate) or CAS No. 52645-53-1), resmethrin, d-trans-allethrin, pralletherin, tetramethrin ((1-cyclohexene-1,2-dicarboximide)methyl-2,2-dimethyl-3-(2-methylpropenyl)cyclopropanecarboxylate), sumithrin (3-phenoxybenzyl-(1RS,3RS;1RS,3SR)-2,2-dimethyl-3-(2-methylprop-1-enyl)cyclopropanecarboxylate), lambda cyhalothrin, piperonyl butoxide and butylcarbityl(6-propylpiperonyl)ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate, others, and so forth and the like. Among these, permethrin, for instance, is an effective termiticide, and, among its other benefits, it also may be considered to have termite feeding inhibiting properties. It is available from many sources. For example, it may be found commercially available in “Permanone 40” or Permanone 90″ (Aventis Environmental Science), with concentrations indicated by the numerals, “40” or “90,” which represent the percents by weight of active ingredients in solution.

Any suitable amount of the insecticide may be employed. The amount may be any that is sufficient to kill, control and/or repel a target invertebrate when the composition is applied to, and preferably dried on or in, a substrate. The insecticide may be, independently at each occurrence, say, from 0.01% to 50% by weight of total composition, say, from 0.1% or 1% to 3%, 5% or 10% by weight of the total composition. Such values may be considered to be approximate or precise. Especially when embodied as a termiticide, the insecticide may be added in an amount by weight of the base fire retardant and fluoropolymer composition, independently at each occurrence, say, at about from 0.5% to 10%, to include about from 0.5%, 0.75% or 1% to 1.5%, 2%, 3%, 4% or 5%. For instance, the termiticide may be added at about from 0.75% to 1.5%, say, about 0.8% to 1%, for example, about 0.9%, by weight of the base fire retardant with fluoropolymer latex paint formulations or base fire retardant with cross-linked component latex paint formulation—with or without mold inhibitor.

The present fire retardant with fluoropolymer or base fire retardant with cross-linked component latex paint compositions, especially as a stain or paint, or even varnish in the case of a solvent based composition, may penetrate to some degree, say, a small amount; and the ammonium phosphate fire retardant plus fluoropolymer, penetrating barrier, borate-containing formulation having resistance to water damage with protective properties coming from materials used in food packaging and cosmetics, and/or medium-to-long chain polar carboxyl substance paint composition may penetrate a substrate. The composition may reside substantially on the surface of the substrate. However that may be, once dried, as a paint it would typically leave a generally opaque film on the surface of a solid substrate, which may be flammable, even though more than one coat may be needed to cover completely. There may be nothing in the present fire retardant with fluoropolymer and base fire retardant with cross-linked component latex paint compositions known to be substantially harmful to wood per se, plywood, any other wood product, or the paper of gypsum board, in general, and further, since such a composition is typically applied on the surface, it should not interact with, degrade, or otherwise deteriorate plywood, sheathing, other types of glued or composite wood products, or paper-clad or paper products, particularly deep in the substrate. With more particular regard to the ammonium phosphate fire retardant plus fluoropolymer, penetrating barrier, borate-containing formulation having resistance to water damage with protective properties coming from materials used in food packaging and cosmetics, and/or medium-to-long chain polar carboxyl substance composition, there may be nothing in it known to be substantially harmful to wood per se, plywood, any other wood product, or the paper of gypsum board, in general, even with penetration of the composition.

The present composition may be applied to the materials by any suitable method. Known methods may be employed. The paint may be applied by spraying, say, by hand-held trigger sprayers, pump-up pressure sprayers, or any other type of manual or automatic power-assisted spraying apparatus, including by power paint rollers (saturated rollers); airless sprayers; brushing; dipping; and so forth. Advantageously, the wet paint is applied by spraying. Brushing is a simple, effective expedient. These and other application processes are well known in the art and are subject to many variations. The composition of the present invention is applied at any suitable concentration or rate to produce a material treated with an effective amount of the same.

The following examples further illustrate the invention, especially the ammonium phosphate fire retardant plus fluoropolymer, penetrating barrier, borate-containing formulation having resistance to water damage with protective properties coming from materials used in food packaging and cosmetics, and/or medium-to-long chain polar carboxyl substance paint:

### EXAMPLE 1

NO-BURN® PLUS fire retardant intumescent latex paint, with and without permethrin insecticide as an optional additional active agent, is(are) combined with DRIWRAP® coating material, KYNAR® AQUATEC® liquid and/or aluminum stearate to make latex paint composition(s). The composition(s) is(are) applied to test cardboard, drywall and/or wood. Satisfactory or even better appearance, durability, water resistance, fire resistance, and optional additional active agent performance, results.

### EXAMPLE 2

NO-BURN® PLUS MIH fire retardant intumescent latex paint with mold inhibitor, with and without permethrin insecticide as an optional additional active agent, is(are) combined with DRIWRAP® coating material, KYNAR® AQUATEC® liquid and/or aluminum stearate to make latex paint composition(s). The composition(s) is(are) applied to test cardboard, drywall and/or wood. Satisfactory or even better appearance, durability, water resistance, fire resistance, mold resistance, and optional additional active agent performance, results.

### CONCLUSION TO THE INVENTION

The present invention is thus provided. Various feature(s), part(s), step(s), subcombination(s) and/or combination(s) may be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

What is claimed is:

1. A composition comprising a fire retardant in combination with a fluoropolymer, wherein the composition is a coating, which is useful as a fire retardant when the composition, after it is applied to, and dried and reached a constant mass on a solid, flammable substrate, i.e., after treatment of the substrate, is effective in reducing surface burning characteristics by at 50% when compared to untreated, solid, flammable substrate as tested by ASTM E84 (Steiner Tunnel Test).

2. The composition of claim 1, which is in a form of a latex paint.

3. The composition of claim 2, which includes ingredients added with water in approximate percentages, as follows:

| | | |
|---|---|---|
| Ammonium phosphate solids | 10 to 40% | by weight |
| Fluoropolymer latex resin | 5 to 30% | by weight |
| Nitrogenous spumific | 5 to 15% | by weight |
| Carbonific | 5 to 15% | by weight |
| Generally inert pigment(s) and/or filler(s) | 5 to 10% | by weight |
| Soda lime borosilicate or other glass | 1 to 5% | by weight |
| Ester alcohol | 0.5 to 1.5% | by weight |
| Hydroxyalkylcellulosic | 0.1 to 1% | by weight |
| Wetting and/or other agent(s) | 0.1 to 5% | by weight. |

4. The composition of claim 3, wherein the fluoropolymer latex resin is or includes a fluoropolymer acrylic type; the nitrogenous spumific is or includes melamine powder; the carbonific is or includes a polyol; and the wetting and/or other agent(s) is, are or include(s) pH adjuster(s) and/or buffer(s).

5. The composition of claim 1, which is in a form of an organic solvent based paint.

6. The composition of claim 5, which has a base formulation that includes ingredients in approximate percentages as follows:

| | | |
|---|---|---|
| Primary solvent of an aromatic organic liquid | 20 to 50% | by weight |
| or blend thereof | | |
| Secondary solvent, which acts as a carbonific, and | 2 to 10% | by weight |
| is a hydroxyl-containing organic compound | | |
| compatible and dispersible with the other | | |
| ingredients | | |
| First film forming agent or polymer of a first | 5 to 15% | by weight |
| (vinyl aromatic)-acrylic resin | | |
| Second film forming agent or polymer of a | 1 to 5% | by weight |
| second (vinyl aromatic)-acrylic resin | | |
| Fire retardant wax of a halogenated paraffin | 3 to 10% | by weight |
| Nitrogenous spumific of a hydrogen-containing | 3 to 10% | by weight |
| nitrogenous organic compound compatible and | | |
| dispersible with the other ingredients | | |
| Carbonific of a polyol | 3 to 10% | by weight |
| Ammonium phosphate | 10 to 30% | by weight |
| Generally inert filler(s) and/or pigment(s) | 5 to 15% | by weight. |

7. The composition of claim 1, which further includes at least one of a mold inhibitor in an amount effective in reducing the growth of Stachybotrys chartarum by at least about 85% for at least about 30 days as tested by ASTM D5590-94 (Determination of Resistance of a Coating Material to Fungal Growth Test) and an insecticide in an amount effective in killing, controlling or repelling a target invertebrate, when the composition is applied to, and dried and reached a constant mass on the solid, flammable substrate, i.e., after treatment of the substrate.

8. The composition of claim 1, which further includes a cross-linked component.

9. In combination, the composition of claim 1 and the substrate on and/or in which the composition and/or a residue thereof reside(s).

10. A composition comprising an ammonium phosphate containing fire retardant, which is in combination with a fluoropolymer, a penetrating barrier, borate-containing formulation having resistance to water damage with protective properties coming from materials used in food packaging and cosmetics, and/or a medium-to-long chain polar carboxyl substance, wherein the composition is a coating, which is useful as a fire retardant when the composition, after it is applied to, and dried and reached a constant mass on a solid, flammable substrate, i.e., after treatment of the substrate, is effective in reducing surface burning characteristics by at 50% when compared to untreated, solid, flammable substrate as tested by ASTM E84 (Steiner Tunnel Test).

11. The composition of claim 10, which is in a form of a latex paint.

12. The composition of claim 11, which includes ingredients added with water in approximate percentages by weight, as follows:

| | |
|---|---|
| Ammonium phosphate solids | 10~40% |
| Nitrogenous spumific | 5~15% |
| Carbonific | 5~15% |
| Generally inert pigment(s) and/or filler(s) | 5~10% |
| Soda lime borosilicate or other glass | 1~5% |
| Ester alcohol | 0.5~1.5% |
| Hydroxyalkylcellulosic | 0.1~1% |
| Wetting and/or other agent(s) | 0.1~5% |
| Fluoropolymer latex resin | *0% or 3~30% |
| Penetrating barrier, borate-containing formulation | *0% or 1~70% |
| having resistance to water damage with | |
| protective properties coming from materials | |
| used in food packaging and cosmetics | |
| Medium-to-long chain polar carboxyl substance | *0% or 0.1~20% |

*Some present from among these three ingredients collectively.

13. The composition of claim 12, wherein the nitrogenous spumific is or includes melamine powder; the carbonific is or includes a polyol; the wetting and/or other agent(s) is, are or include(s) pH adjuster(s) and/or buffer(s); the fluoropolymer resin is or includes a fluoropolymer acrylic type resin; the penetrating barrier, borate-containing formulation having resistance to water damage with protective properties coming from materials used in food packaging and cosmetics is a coating material; and the medium-to-long chain polar carboxyl substance, when considered as a pure compound, accords with the following general formula:
(R—COO)ₘ-M
wherein:
“R” is, independently at each occurrence, an aliphatic moiety of about from ten to thirty carbons;
“m” is a suitable number, say, an integer of 1 or greater; and
“M” is, independently at each occurrence, H so as to make an acid provided that “m” is 1; an organic ester moiety so as to make an ester; and/or or a metal with a valence of “m,” so as to make a salt.

14. The composition of claim 10, which further includes at least one of a mold inhibitor in an amount effective in reducing the growth of Stachybotrys chartarum by at least about 85% for at least about 30 days as tested by ASTM D5590-94 (Determination of Resistance of a Coating Material to Fungal Growth Test) and an insecticide in an amount effective in killing, controlling or repelling a target invertebrate, when the composition is applied to, and dried and reached a constant mass on the solid, flammable substrate, i.e., after treatment of the substrate.

15. The composition of claim 10, which further includes a cross-linked component.

16. In combination, the composition of claim 10 and the substrate on and/or in which the composition and/or a residue thereof reside(s).

17. A composition comprising a fire retardant formulation having a cross-linked component, which is a latex paint coating and is useful as a fire retardant when the composition, after it is applied to, and dried and reached a constant mass on a solid, flammable substrate, i.e., after treatment of the substrate, is effective in reducing surface burning characteristics by at 50% when compared to untreated, solid, flammable substrate as tested by ASTM E84 (Steiner Tunnel Test).

18. The composition of claim 17, which includes ingredients added with water in approximate percentages, as follows:

| | | |
|---|---|---|
| Ammonium phosphate solids | 10 to 40% | by weight |
| Thermoplastic latex resin | 5 to 30% | by weight |
| Nitrogenous spumific | 5 to 15% | by weight |
| Carbonific | 5 to 15% | by weight |
| Generally inert pigment(s) and/or filler(s) | 5 to 10% | by weight |
| Soda lime borosilicate or other glass | 1 to 5% | by weight |
| Ester alcohol | 0.5 to 1.5% | by weight |
| Hydroxyalkylcellulosic | 0.1 to 1% | by weight |
| Cross-linking agent | 0.1 to 2% | by weight |
| Lower alkyl alcohol | 0.1 to 2% | by weight |
| Wetting and/or other agent(s) | 0.1 to 5% | by weight. |

19. The composition of claim 17, which further includes at least one of a mold inhibitor in an amount effective in reducing the growth of Stachybotrys chartarum by at least about 85% for at least about 30 days as tested by ASTM D5590-94 (Determination of Resistance of a Coating Material to Fungal Growth Test) and an insecticide in an amount effective in killing, controlling or repelling a target invertebrate, when the composition is applied to, and dried and reached a constant mass on the solid, flammable substrate, i.e., after treatment of the substrate.

20. In combination, the composition of claim 17 and the substrate on and/or in which the composition and/or a residue thereof reside(s).
